(19) United States
(12) Patent Application Publication
(10) Pub. No.: US 2007/0285018 A1
(43) Pub. Date: Dec. 13, 2007

(54) Coaxial cavity gyrotron with two electron beams

(76) Inventors: Shenggang Liu, Williamsburg, VA (US); Chaoyu Liu, Williamsburg, VA (US)

Correspondence Address: Kimberly A. Chasteen, PO Box 1243, Yorktown, VA, 23692, US

(21) Appl. No.: 11/639,971

(22) Filed: Dec. 15, 2006

(30) Foreign Application Priority Data
Dec. 15, 2005 (CN) 200510022310.4

(51) Int. Cl. H01J 23/34

(52) U.S. Cl. 315/1

(57) ABSTRACT

A coaxial cavity gyrotron with two electron beams includes an electron gun (magnetron injection gun, “MIG,” with two beams), a coaxial cavity and a magnetic field tube. The coaxial cavity consists of two parts: an outer conductor 1 and an inner conductor 4. The two hollow electron beams 2, 3 produced by the electron gun are located between the outer conductor 1 and the inner conductor 4. The MIG with two electron beams includes inner and outer anodes 7, 8 with a cathode 9 located between the anodes. The cathode further includes two emitter rings 9a, 9b which produce the two hollow electron beams 2, 3. The entire gyrotron is immersed in the magnetic field tube such that the magnetic field profile is the same or similar to that for a coaxial gyrotron with one electron beam.

### CROSS REFERENCE TO RELATED APPLICATIONS:

The present application claims priority from Chinese patent application no. 200510022310.4, filed Dec. 15, 2005.

### BACKGROUND

1. Field of Invention

This invention relates generally to high-power millimeter wave facilities. Particularly, this invention relates to a coaxial cavity gyrotron and an electron gun in the nature of a special magnetic injection gun with two electron beams.

2. Description of Prior Art

Assuring the availability of energy sources is a significant issue confronting every country. Research and exploration of new energy sources are considered to be of great importance by many countries and scientists. Controlled thermonuclear fusion reaction may provide the most promising solution in the form of a new and clean energy source. In the planned International Thermonuclear Experimental Reactor, “ITER,” project, high-density plasma is heated to hundred millions of degrees to result in a nuclear fusion reaction to produce a rich and clean source of energy. The key of this project is plasma heating. A gyrotron is applied in the heating process of ITER plasma. Therefore, having a gyrotron with increased output power and improved efficiency are critical.

### SUMMARY OF THE INVENTION

In accordance with the present invention a Coaxial Cavity Gyrotron system is composed of a Coaxial Cavity Gyrotron and a plurality of hollow electron beams. The hollow electron beams are produced by an electron gun. The electron beam-wave interaction transfers the kinetic energy of the electrons to the wave, and then the electromagnetic wave is greatly increased. The high power electromagnetic wave is output through an output window. In addition to being used in energy production, the Coaxial Gyrotron system can also be applied in millimeter wave radar systems and other areas in industry. The research of coaxial gyrotrons has attracted great attention in all over the world in order to enhance the output power, increase the efficiency and improve the mode competition.

An improved coaxial cavity gyrotron includes an electron gun capable of producing at least two electron beams, a magnetic field tube, and a coaxial cavity located within the magnetic field tube. The coaxial cavity gyrotron consists of an outer conductor and an inner conductor, in between which, the two electron beams are formed symmetrically. Both the coaxial cavity and the magnetic field tube are generally circular in cross-section. The coaxial cavity is located inside the magnetic field tube. The preferred electron gun of the present invention includes an inner anode, an outer anode and a cathode located in between the anodes; the inner anode is connected directly to an electron of the coaxial cavity. Two emitter rings are located on the cathode of the electron gun for forming the two hollow electron beams. The electron gun is immersed in an adiabatic varying magnetic field. In use, the coaxial cavity gyrotron is immersed in a uniform magnetic field.

### BRIEF DESCRIPTION OF THE DRAWINGS

FIG. 1 is a Coaxial Cavity Gyrotron with two beams, CCGT;

FIG. 2 is a cross-sectional view of the CCGT taken across line A-A of FIG. 1;

FIG. 3 is a cross-sectional view of an assembled CCGT with the special Magnetron Injection Gun, MIG;

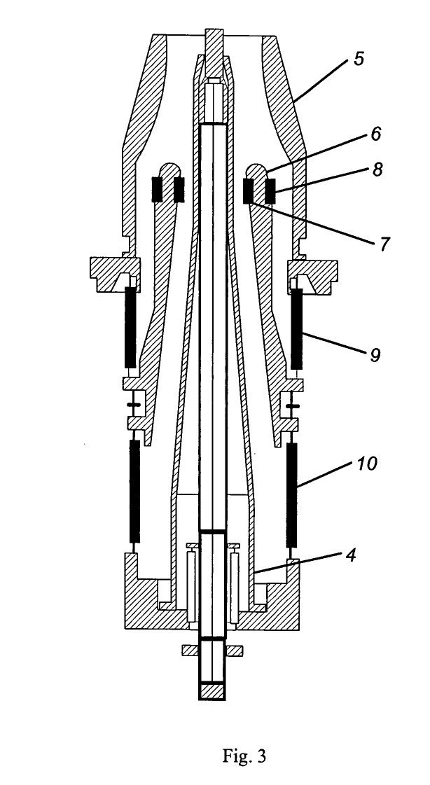

FIG. 4 is a schematic view of the CCGT with two electron beams; and

FIG. 5 is a magnetic field profile for the MIG.

### DESCRIPTION OF THE PREFERRED EMBODIMENTS

The following detailed description is of the best presently contemplated mode of carrying out the invention. This description is not to be taken in a limiting sense, but is made merely for the purpose of illustrating general principles of embodiments of the invention. The detailed description set forth below in connection with the appended drawings is intended as a description of presently preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

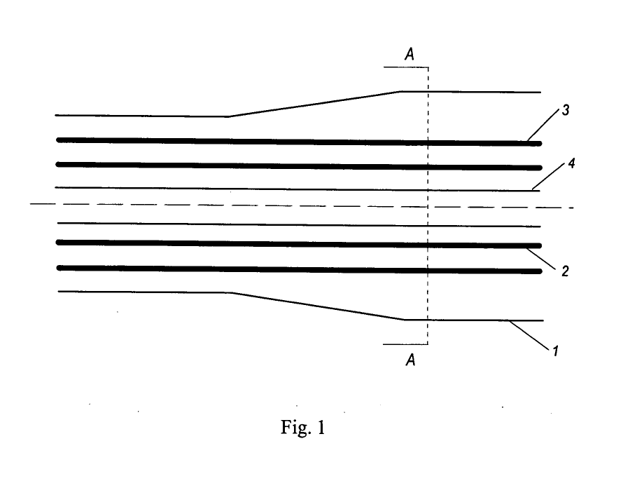

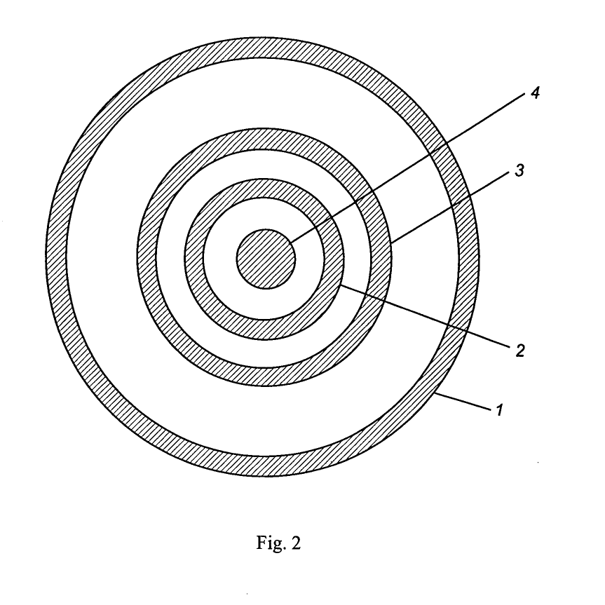

The aim of this invention is to provide a new gyrotron, a Coaxial Cavity Gyrotron with two electron beams and a new magnetron injection gun for producing two electron beams to make a gyrotron with higher power, improved mode competition and higher efficiency. It is composed of an electron gun (preferably, a special magnetic injection gun (MIG)), a coaxial cavity and a magnetic field tube. The coaxial cavity consists of two parts: an outer conductor (1) and an inner conductor (4). Two hollow electron beams (2), (3) are produced by the electron gun and are located between the outer conductor (1) and the inner conductor (4). See FIG. 1. The coaxial cavity is located inside the magnetic field tube, whose magnetic field shape is the same as or similar to that for a coaxial cavity gyrotron with one electron beam. The cross-sections of the inner and outer conductors (1, 4) and magnetic tube are generally circular, see FIG. 2.

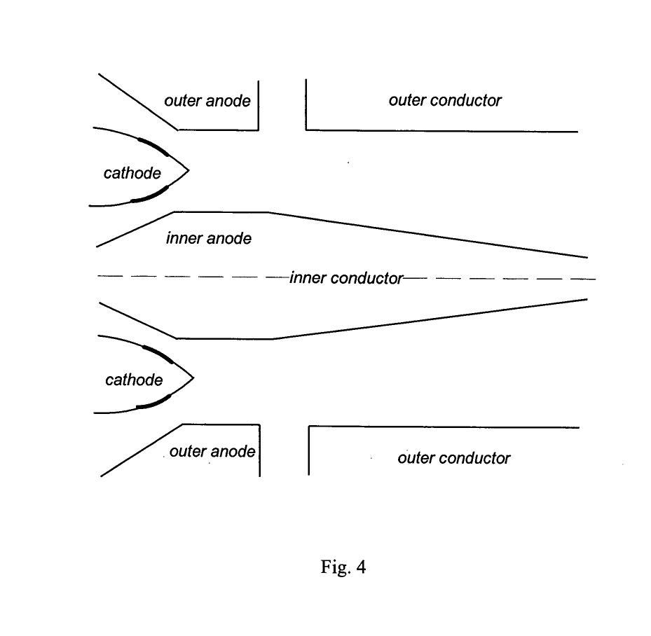

n a preferred embodiment, the electron gun, a special MIG, has a cathode (9), outer anode (8) and inner anode (7), see the structure of the MIG shown in FIG. 4, and there are two emitting rings (emitters)(9a) and (9b), shown in FIG. 4, which produce the two hollow electron beams (2, 3) (see FIG. 1.).

A high power gyrotron is the key device for plasma heating to produce the thermonuclear fusion, one of the most promising solutions to the human energy crisis. The ITER project is a world wide joint project for this purpose. However, the current gyrotron is not able to provide one exact continuous wave megawatt. Therefore, the Coaxial Cavity Gyrotron of this invention has extreme significance.

A new type of gyrotron, the Coaxial Cavity Gyrotron with two-electron beams is composed of a coaxial cavity and two coaxial hollow electron beams. Compared with the ordinary gyrotron with one electron beam, it achieves a better performance based on a theoretical study and computer simulations. First, when the novel two-electron beam system is adopted, the working current is increased greatly; therefore the output power will be increased by two to four times. Second, the two-electron beam system achieves the best beam-wave interaction, so it may output higher power with higher efficiency. The theoretical study shows that it is expected to provide up to 72% efficiency, much higher than that for a gyrotron with one beam. The mode competition is also improved when the two-beam system is used.

This invention also proves that a Coaxial Cavity Gyrotron with two-electron beam is able to operate at dual-frequency, it can output two different frequencies with high power, i.e. one is the basic frequency, the other is the multiple frequency, which has important application value.

The essential part of this invention is the adoption of a two-electron beam system, i.e. there are two hollow electron beams inside the coaxial gyrotron. The potentials of the two beams are proved the same. This invention is able to increase the output power of coaxial gyrotron as well as the improved model competition.

Application: The coaxial cavity gyrotron with two-electron beams is composed of a coaxial cavity outer electrode (1), two hollow electron beams (2, 3), and a coaxial cavity inner electrode (4), as illustrated in FIG. 1. The coaxial cavity gyrotron with two electron beams is located inside a strong magnetic field, whose magnetic field shape is the same as or similar to that of a coaxial gyrotron with a single electron beam. Electrons interact with the EM wave in this magnetic field, therefore, the kinetic energy of electrons is transferred into the energy of microwave wave, and a stronger microwave power is produced.

The working process indicates that two coaxial hollow electron beams (2, 3) produced by the electron gun (preferably, a magnetron injection gun or “MIG”), are injected into the coaxial cavity (1, 4). These two coaxial hollow electron beams (2, 3) interact with electromagnetic wave fields inside the coaxial cavity (1, 4). When the electron cyclotron frequency is close to that of the coaxial cavity, based on the theory of electron cyclotron maser instability, the electromagnetic wave power will be greatly increased and then outputs.

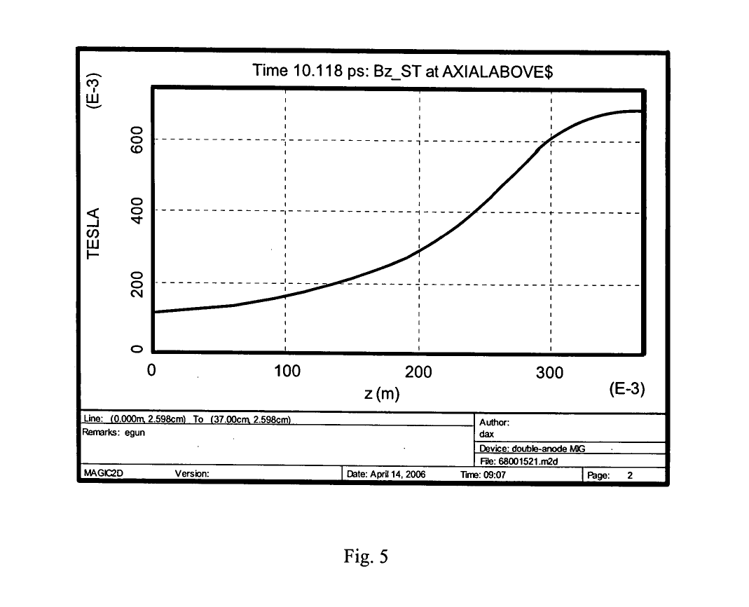

In the preferred embodiment, the electron gun is a special magnetic injection gun (MIG) which has a cathode (9) between outer anode (8) and inner anode (7), the schematic structure of the MIG is shown in FIG. 4. There are two emitting rings (emitters)(9a) and (9b) which produce the two hollow electron beams (2, 3) shown in FIG. 1. The MIG is immersed in an adiabatic varying magnetic field shown in FIG. 5, and the entire coaxial cavity gyrotron is immersed in a uniform magnetic field, the intensity of which is determined by the operation frequency at the cyclotron frequency or harmonic of the cyclotron frequency.

While the present invention has been described with regards to particular embodiments, it is regcognized that additional variations of the present invention may be devised without departing from the inventive concept. Many improvements, modifications, and additions will be apparent to the skilled artisan without departing from the spirit and scope of the present invention as described herein and defined in the following claims.

What is claimed is:

1. A coaxial cavity gyrotron, comprising:
an electron gun capable of producing at least two electron beams;
a magnetic field tube; and
a coaxial cavity located within the magnetic field tube.

2. The coaxial cavity gyrotron of claim 1 wherein the coaxial cavity comprises:
an outer conductor; and
an inner conductor.

3. The coaxial cavity gyrotron of claim 2 wherein said at least two electron beams are symmetrically formed between the inner conductor and the outer conductor.

4. The coaxial cavity gyrotron of claim 1 wherein the coaxial cavity and the magnetic field tube are generally circular in cross-section.

5. The coaxial cavity gyrotron of claim 1 wherein the coaxial cavity is located inside the magnetic field tube.

6. The coaxial cavity gyrotron of claim 5 wherein the coaxial cavity and the magnetic field tube are generally circular in cross-section.

7. The coaxial cavity gyrotron of claim 1 wherein the electron gun comprises:
an inner anode;
an outer anode; and
a cathode.

8. The coaxial cavity gyrotron of claim 7 wherein the inner anode is connected directly to an electrode of the coaxial cavity.

9. The coaxial cavity gyrotron of claim 7 wherein the cathode includes a first emitter on the outer surface of the cathode and a second emitter on the inner surface of the cathode.

10. The coaxial cavity gyrotron of claim 7 wherein the cathode is located in between the inner anode and the outer anode.

11. The coaxial cavity gyrotron of claim 1 wherein the electron gun is immersed in an adiabatic varying magnetic field.

12. The coaxial cavity gyrotron of claim 1 wherein the electron gun, the coaxial cavity and the magnetic field tube are immersed in a uniform magnetic field.

13. The electron gun of claim 1, comprising:
an inner anode;
an outer anode;
a cathode in between the inner anode and the outer anode;
an outer emitter ring located on the outer surface of the cathode; and
an inner emitter ring located on the inner surface of the cathode, wherein the inner and outer emitter rings produce two hollow electron beams.
